(19) United States
(12) Patent Application Publication
(10) Pub. No.: US 2015/0058333 A1
(43) Pub. Date: Feb. 26, 2015

(54) GENERATING SEQUENCES OF PROGRAM ITEMS

(71) Applicant: YAHOO! INC., Sunnyvale, CA (US)

(72) Inventors: Amir Doron, San Diego, CA (US); Anthony Jesse Foiani, San Deigo, CA (US); Kevin Sitze, San Diego, CA (US); Sean Sullivan, San Diego, CA (US)

(21) Appl. No.: 14/527,104

(22) Filed: Oct. 29, 2014

Related U.S. Application Data
(62) Division of application No. 10/730,810, filed on Dec. 8, 2003.
(60) Provisional application No. 60/431,257, filed on Dec. 6, 2002.

(51) Int. Cl. G06F 17/30

(52) U.S. Cl. CPC G06F 17/30769
USPC 707/723; 707/722

(57) ABSTRACT

Systems and techniques, including computer program products, for generating sequences of program items. A specification of a sequence is received. A specification of multiple sets, where each set includes one or more program items, is also received. An output sequence of program items is generated by selecting program items from the sets based on the specified sequence. In some implementations, program items are selected by assigning each program item a score, and identifying the program item with the best score. An attribute can be associated with each program item. The attributes can be used to group the program items into sets, to determine the scores of the program items, and to select program items to be placed in the generated output sequence. The rules and the set sequence can be adjusted dynamically, and the generated output sequence can be modified by adding, removing, or replacing program items.

### CROSS-REFERENCE TO RELATED APPLICATION

This application claims priority to U.S. Provisional Application No. 60/431,257, entitled “Automatic Generation of Radio Station Programming,” which was filed on Dec. 6, 2002. The disclosure of the above application is incorporated herein by reference in its entirety.

### BACKGROUND

The present application relates to programming, and more particularly to generating sequences of program items.

Station programming (e.g., radio station programming) is conventionally done by a programmer (e.g., a disc jockey) who selects program items (e.g., songs) in an order that produces a varied and desirable program flow. The station programmer may create such a program flow by generating a selection of program items that meets (or comes close to meeting) certain criteria. For example, a disc jockey may generate programming for a radio station by applying the following criteria: do not repeat the same song too often, do not repeat songs from the same artist too often, do not play too many slow songs or too many fast songs in a row, do not play too many very popular songs in a row, and so forth.

### SUMMARY

The present application provides systems and techniques for generating sequences of program items.

In one aspect, the systems and techniques feature a computer program product with instructions that are operable to cause data processing apparatus to receive a specification of a sequence, to receive a specification (e.g., an identification) of multiple sets, where each set includes one or more program items, and to generate an output sequence of program items by selecting the program items from the sets based on the specified sequence.

Advantageous implementations can include one or more of the following features. The specified sequence can be based on user data. There can be at least one attribute associated with each program item, and the selection of the program items can be further based on the attributes. The attributes can be based on user data.

Selecting the program items can include assigning each program item a score based on one or more rules, and identifying a best program item based on the score of each program item. Each score can represent a penalty based on compliance with the rules, and the best program item can be the program item with the lowest penalty. An attribute can be associated with each program item, and one or more of the rules can be based on the attribute. The rules can also be based on user data.

One or more of the rules can be dynamically generated. A dynamically generated rule can reference one or more indicated program items in the output sequence of the program items. A rule can include an indication of a period of time during which the rule is to apply. The indication of the period of time can include a specification of a number of program items in the output sequence of the program items. A rule can also include an indication of one or more specific program items to which the rule is to apply. An error can be generated if the score of the best program item does not meet a threshold value.

The specified sequence can be adjusted based on user data. The user data can include a specification of a setting on a GUI control. The GUI control can have two or more degrees of freedom. The availability of one or more of the program items can be adjusted based on a second setting on the GUI control. The availability of program items can be adjusted by establishing a rule and selecting program items from the sets based on the rule.

The output sequence of the program items can be modified. Program items can be removed from or added to the output sequence of the program items. Program items in the output sequence can also be replaced with alternative program items.

Where the output sequence of the program items contains a proxy that represents two or more related program items, the proxy can be replaced with one or more of the related program items.

The output sequence of program items can be combined with at least one additional sequence of program items. Program items can be selected from the output sequence and from additional sequences according to weights associated with the output sequence and the additional sequences.

In another aspect, the systems and techniques feature a method that includes receiving a specification of a sequence, receiving a specification (e.g., an identification) of multiple sets, where each set includes one or more program items, and generating an output sequence of program items by selecting the program items from the sets based on the specified sequence.

In another aspect, the systems and techniques feature an apparatus that includes means for receiving a specification of a sequence, means for receiving a specification (e.g., an identification) of multiple sets, where each set includes one or more program items, and means for generating an output sequence of program items by selecting the program items from the sets based on the specified sequence.

In yet another aspect, the systems and techniques feature a computer program product with instructions that are operable to cause data processing apparatus to receive a specification of program items, and, for each program item, an attribute, group the program items into sets based on the attribute of each program item, receive a specification of a sequence, and select the program items from the sets based on the specified sequence.

Advantageous implementations can include one or more of the following features. The specification of the program items can include a list of program items based on user data. The attribute associated with each program item can also be based on user data. Attributes can be based on play counts or licensing information associated with the program items.

Grouping the program items can include sorting the program items by the attribute of each program item. Grouping the program items can also include assigning the program items to the sets in the order of the attribute of each program item.

A specification of one or more additional attributes can be received for each program item. Grouping the program items into the sets can be further based on the additional attributes for each program item.

Selecting the program items can be based on the attribute for each program item. Selecting the program items can also include assigning each program item a score based on one or more rules, and identifying a best program item based on the score of each program item.

The systems and techniques described herein can be implemented to realize one or more of the following advantages. The systems and techniques can be used to automate station programming. The systems and techniques can be used to apply programming criteria effectively, and to generate intelligent and appealing sequences of program items that approach the quality and variety of program flows generated by human programmers. The systems and techniques can be used to program a large number of individualized or customized stations. The systems and techniques can be used in many different contexts and environments, either on their own or in conjunction with other tools. Such tools can include tools that produce input for the systems and techniques described herein (e.g., recommendation engines that create dynamic sets of program items to be sequenced), as well as tools that modify the generated output (e.g., tools that filter the program items in a generated program sequence). One implementation can achieve all of the above advantages.

Details of one or more implementations are set forth in the accompanying drawings and in the description below. Other features and advantages will become apparent from the description, the drawings, and the claims.

### BRIEF DESCRIPTION OF THE DRAWINGS

FIG. 1 illustrates a block diagram of a programming system.

FIG. 2 illustrates a block diagram of another programming system.

FIG. 3 is a flowchart that depicts a process for generating a sequence of program items.

FIG. 4 is a flowchart that depicts a process for separating program items into multiple sets.

Like reference symbols in the various drawings indicate like elements.

### DETAILED DESCRIPTION

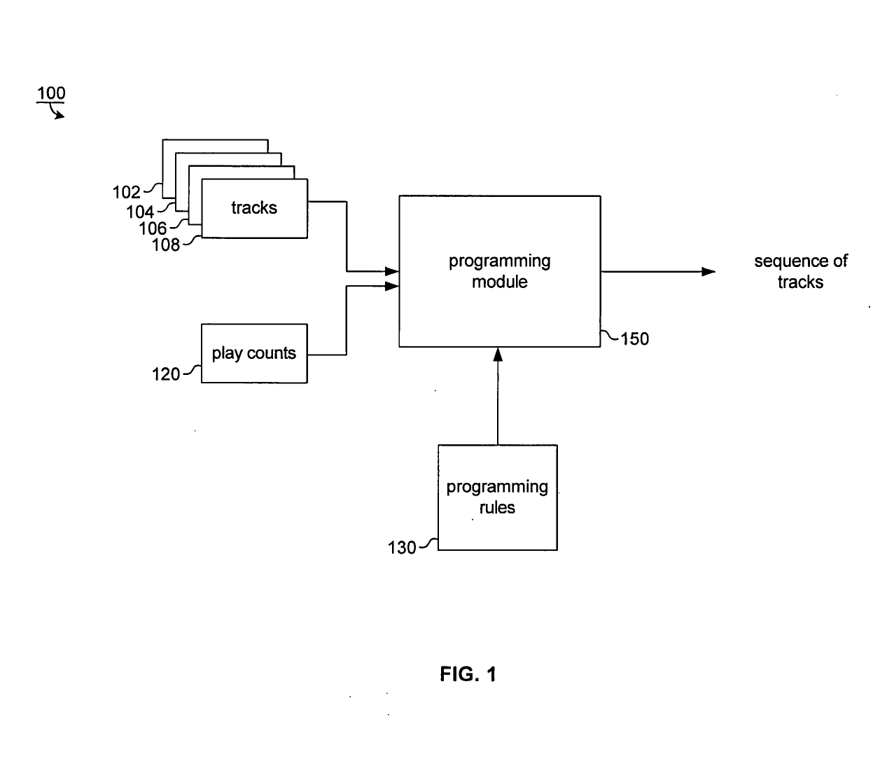

FIG. 1 illustrates a high-level diagram of a programming system 100. The system includes a programming module 150, whose job it is to take a given set of program items (e.g., tracks 102, 104, 106, and 108), and generate a sequence in which to play the program items. For example, given tracks 102, 104, 106, and 108, the programming module can decide that the tracks should be played in the following sequence: track 102, track 104, track 102, track 106, and track 108. After a program item has been played, its status can be marked as “unavailable,” so that it will not be played again for a period of time (e.g., until all the other program items have been played). Alternatively, the status of the program item can be marked as “available,” so that the program item can still be selected by the programming module and inserted again into the generated sequence of program items.

Though displayed as tracks or songs in FIG. 1, the program items that serve as input to the programming module 150 can be many different types of items. For example, program items can be music videos to be played on a music video cable station, advertisements to be played on a television station or displayed on a web page, news items to be displayed on a ticker (e.g., across the bottom of the screen of a news station), or trailers to be shown as previews before a movie. In general, program items can be any discrete items of content (e.g., text messages, pictures, songs, videos, documents, files, etc.). In some implementations, program items can include proxies. A proxy is an item that represents a bundle or group of related program items. The use of proxies is discussed in more detail below. An input set of program items can include different types of program items (e.g., songs, advertisements, and pictures).

The set or universe of program items that serves as input to the programming module 150 can come from many different sources. For example, the universe of program items can be tracks on a compact disc (CD) or in a user's media library on a personal computer, or a list of tracks specified by the user. In one implementation, the programming system 100 is used to generate intelligent sequences of songs for Internet radio stations. In such an implementation, the input set of program items can be specified by content programmers (e.g., to produce pre-programmed stations, such as a classic rock station, a blues station, a smooth jazz station, an 80s hits station, etc.).

The input set of program items can also be created dynamically. For example, a user can specify the name of an artist that he or she likes, and a list of the available songs from that artist can be compiled and used as input to the programming module 150. (An Internet radio station that works in this manner is sometimes referred to as an “on-demand” radio station.) As another example, a list of songs can be assembled based on a user profile (which can include data provided by a user as well as data collected or determined about the user). As another example, a user can be identified as belonging to a certain affinity group or as having requested songs of a particular genre, and a list of songs that combines songs specified by the user and songs previously associated with the affinity group or with the genre can be assembled and used as input to the programming module 150. As yet another example, a user can specify the name of an artist, and a list of songs from that artist, as well as from additional artists identified by a recommendation engine, can be complied and used as input to the programming module 150. The programming module 150 can thus be used in conjunction with existing programming products (e.g., Selector), and can generate appropriate sequences of program items for many different types of stations (e.g., over-the-air radio stations, Internet radio stations, cable TV stations, etc.). In general, the input set of program items can be based on multiple types of user data. User data can include, for example, information from a user (e.g., information provided through user input), information about a user (e.g., information from a user profile), or information from or about a group of users (e.g., information from or about a user affinity group).

In some implementations, the input set of program items is determined by using various operations to create a subset of program items from a master set of available program items. For example, for a radio station, the input set of program items can be determined by selecting songs from a particular artist, or songs of a particular genre, from a master list of all the songs that are available (e.g., all the songs that have been licensed for the radio station).

To generate an intelligent sequence of program items, the programming module 150 can use various data (e.g., play count information 120) and a set of programming rules 130. In one implementation, the data includes one or more attributes for each program item in the input set of program items. Attributes can be metrics that specify various information about program items. For example, an attribute can be a rank that indicates which program items are favored. The rank of a program item can be, for example, play count information for that program item, based on data from a distributed database (e.g., data indicating how often a song has been downloaded or streamed). Ranks can also be based on user data. For example; ranks can be based on information from users (e.g., through an explicit ranking of songs provided by the user), or from user profiles or user affinity groups (e.g., through average ratings provided by members of an affinity group, or through other external data associated with the affinity group). Other attributes can also be based on user data and other similar sources of data.

Another example of an attribute that can be used in the determination of how to sequence program items is licensing information. For example, royalty fees can serve as a proxy for popularity, so that songs with higher royalties can be presumed to be more popular and thus played more frequently. Alternatively, songs with higher royalties can be played less frequently so as to minimize licensing costs.

An attribute can also be a binary variable that represents whether a certain condition applies or exists with respect to a program item. For example, where an Internet radio station allows songs from artists to be compiled and played “on demand,” an attribute can specify whether a certain song has been licensed or otherwise approved for “on demand” play. An attribute can also be a variable that represents various information about or associated with a program item (e.g., the name of a song or the name of an artist, or a distance metric representing the degree of relationship that a program item has with respect to a certain property). As described above, attributes can be based on user data and other sources of data. In some implementations, each attribute has an attribute type and an attribute value.

The programming rules 130 can represent various criteria (e.g., the programming criteria discussed above) and strategies that can be used to generate suitable sequences of program items. The use of programming rules is discussed in more detail below.

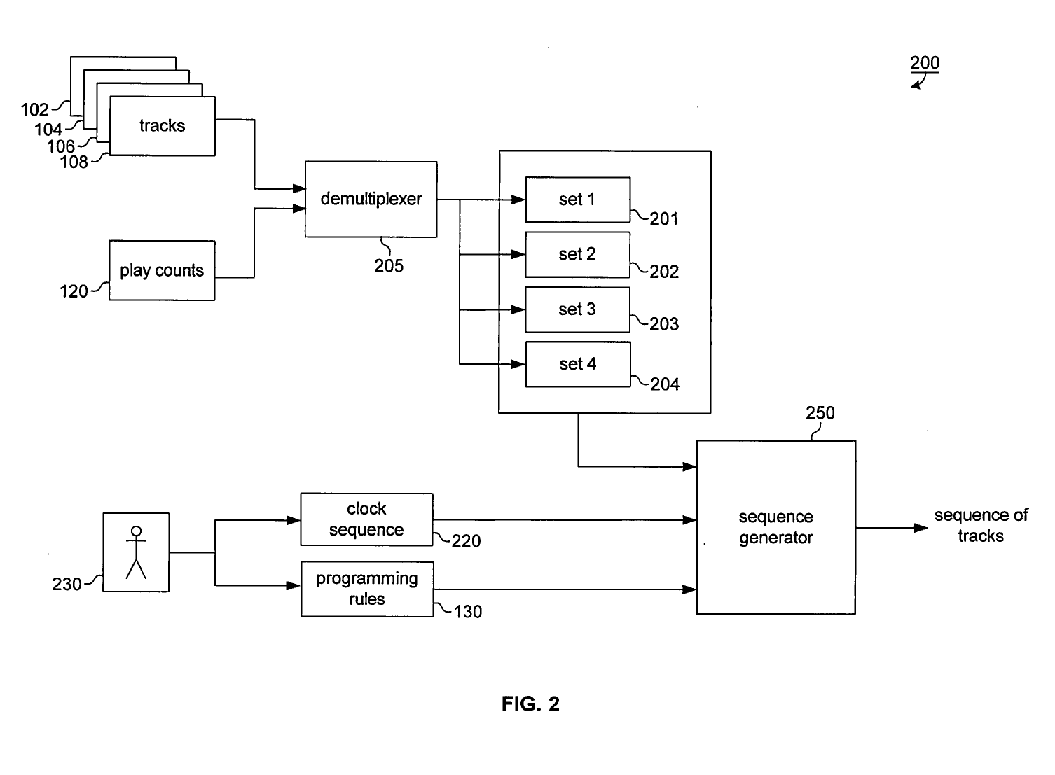

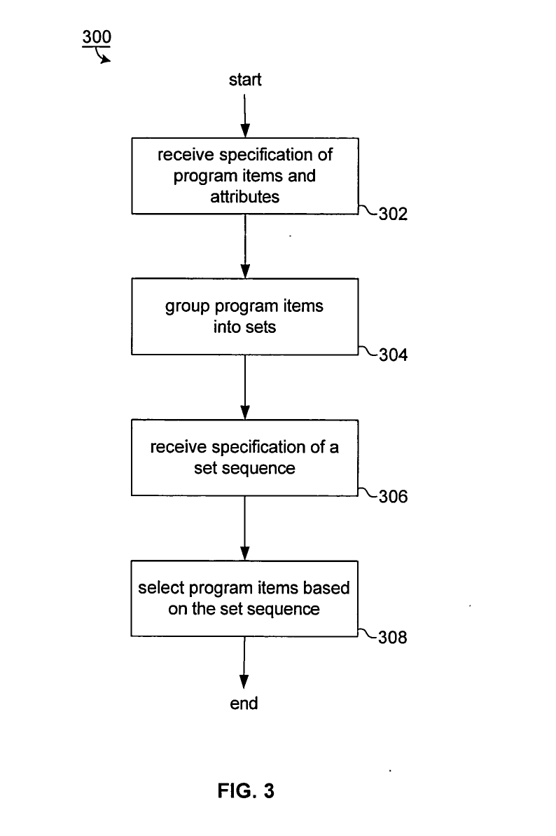

FIG. 2 illustrates a block diagram of another programming system 200. The operation of the programming system 200 in FIG. 2 is described in conjunction with the sample process 300 shown in FIG. 3 for generating sequences of program items.

In step 302, the system 200 receives a specification of program items and attributes (e.g., the list of tracks 102, 104, 106, 108, and the play count information 120 shown in FIG. 2). The system then groups the program items into sets (step 304), which are sometimes referred to as “buckets.” In FIG. 2, step 304 is carried out by a demultiplexer 205, which divides the input tracks into four sets 201, 202, 203, and 204. In one implementation, program items are grouped into sets based on the attributes associated with the program items. Where the attributes represent ranks, the sets can represent the relative ranks of the program items. For example, in one implementation, the tracks in the first set (201) are generally ranked higher than the tracks in second set (202), the tracks in the second set (202) are generally ranked higher than the tracks in the third set (203), and the tracks in the third set (203) are generally ranked higher than the tracks in the fourth set (204).

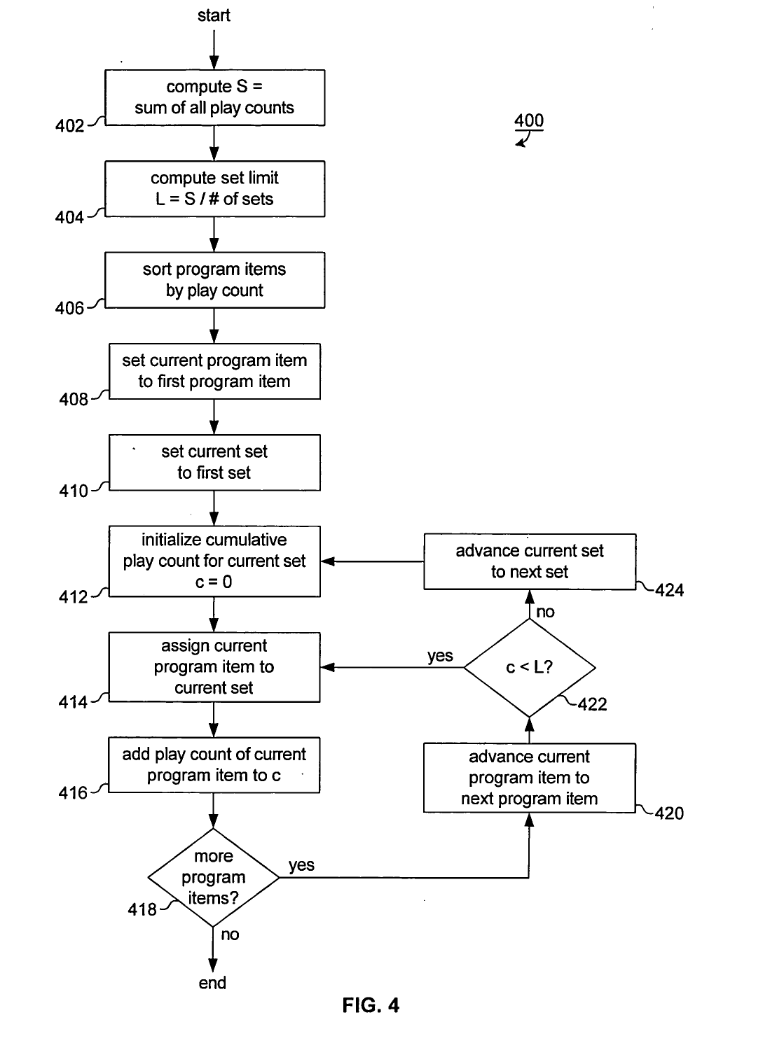

Various algorithms can be used to assign program items to sets. FIG. 4 illustrates an example of such an algorithm. In this example, the attribute associated with each program item is a play count. In the process 400 shown in FIG. 4, the sum of the play counts of all the program items is calculated and assigned to the variable S (step 402). A set limit, L, is then computed by dividing S by the number of sets (step 404). Next, the program items are sorted by their play counts (step 406). The program items are then assigned to sets in turn (i.e., in the order of their play counts). To initiate the iterations through the set of program items, the current program item (i.e., a pointer to the next program item to be assigned) is set to the first program item (step 408), and the current set (i.e., a pointer to the set to which to assign program items) is set to the first set (step 410). The variable c, which represents the sum of the play counts of all the program items that have been assigned to the current set, is set to zero (step 412).

The current program item is then assigned to the current set (step 414), and the play count of the program item is added to c (step 416). The process then checks whether there are more program items to assign (step 418). If there are no more program items to assign, the process ends.

If there are more program items to assign, the current program item is advanced to the next program item (step 420). The process then checks whether c, the sum of the play counts of all the program items that have been assigned to the current set, is less than L, the set limit (step 422). If c is less than L, the process returns to step 414, so that the current program item can be added to the current set, and the play count of the program item can be added to c.

If, on the other hand, c equals or exceeds the set limit L, the current set is deemed full and additional program items are added to the next set. Thus, the current set is advanced to the next set (step 424), and the process returns to step 412, where c is reset to zero for the new current set.

To illustrate how the process 400 works, consider an example in which 8 songs (a, b, c, d, e, f, g, and h) are to be divided into 4 sets. In this example, the play counts of the songs are shown in Table 1 below.

TABLE 1

| Song | Play Count |
|---|---|
| a | 100 |
| b | 80 |
| c | 50 |
| d | 24 |
| e | 20 |
| f | 10 |
| g | 9 |
| h | 7 |

The first step is to compute S, the sum of all the play counts. In this example, S=300. The set limit L is then computed by dividing S by 4, the number of sets. Thus, L=300/4=75.

The songs are then sorted by their play counts (in this example, they are already sorted). The current program item is set to the first song (a), the current set is set to the first set, and c is set to 0 for the current set.

The current program item, a, is then assigned to the current set, and the play count of the song is added to c (so c now equals 100). Since there are more songs to assign, the current song is set to the next song (b). Since c is greater than the set limit L, the current set is advanced to the next set (the second set), and c is reset to 0 for the new current set.

The current program item, b, is then assigned to the current set, and the play count of the song is added to c (so c now equals 80). Since there are more songs to assign, the current song is set to the next song (c). Since c is greater than the set limit L, the current set is advanced to the next set (the third set), and c is reset to 0 for the new current set.

The current program item, c, is then assigned to the current set, and the play count of the song is added to the variable c (so c now equals 50). Since there are more songs to assign, the current song is set to the next song (d). The variable c is less than the set limit L, so the current program item, d, is also assigned to the current set (the third set), and the play count of the song is added to c (so c now equals 50+24=74). Since there are more songs to assign, the current song is set to the next song (e). The variable c is still less than the set limit L, so the current program item, e, is also assigned to the current set (the third set), and the play count of the song is added to c (so c now equals 74+20=94). Since there are more songs to assign, the current song is set to the next song (f). Now, c exceeds the set limit L, so the current set is advanced to the next and final set (the fourth set). Looping through the process in a similar fashion, songs f, g, and h are added to the fourth set. Thus, after the process terminates, the songs are divided into 4 sets as shown in Table 2 below.

TABLE 2

| Set | Songs |
|---|---|
| 1 | a |
| 2 | b |
| 3 | c, d, e |
| 4 | f, g, h |

As can be seen from the example above, the process 400 distributes program items into sets so that the cumulative play counts of the program items will be roughly equal across all the sets. The first set will contain the highest-ranking program items (e.g., the most popular songs). Each subsequent set will contain lower-ranking program items, with the final set containing the lowest-ranking program items (e.g., the least popular songs). Such a distribution of program items can help to create an appealing program flow, as is described below.

Though the number of sets can be set to any desired value, in some implementations, the number of sets is chosen to reflect the number of “types” of program items that exist. For example, in an implementation in which songs are grouped into sets according to their play counts, the number of sets can be set to 4, to represent 4 types of songs—very popular, somewhat popular, not very popular, and almost unknown.

Various modifications can be made to the process for assigning program items to sets. In an implementation in which attributes represent ranks, program items can be assigned to sets with the ultimate goal of preserving the rank of the program items, even if the resulting distribution among sets is not as even as could otherwise be attained. In such an implementation, lower-ranked program items are not promoted (assigned) ahead of higher-ranked program items. In an alternative implementation, lower-ranked program items can be promoted ahead of higher-ranked program items. For example, assuming the set limit L is 100, the cumulative play count for the current set is 99, and the play count of the current song is 25, a song whose play count is 1 (a lower-ranking song) can be assigned to the current set ahead of the current song (a higher-ranking song) in order to “fill up” the current set. Allowing program items to be promoted can result in the cumulative ranks of the program items being more equal across all the sets.

In some implementations, program items can be processed (e.g., grouped and sorted) in different ways before being assigned to sets. For example, for a given set of songs, the artists corresponding to those songs can be determined. The songs for each artist can then be sorted and assigned to sets using the process specified above.

In alternative implementations, the program items can be assigned to sets without sorting the program items (e.g., without sorting the program items in order of their ranks). For example, in some implementations, the demultiplexer 205 can choose program items to assign randomly, or otherwise randomize the assignment of program items. In implementations where there are multiple attributes associated with each program item, more than one attribute can be taken into account and used in determining how to assign program items to sets. For example, an algorithm might assign program items to sets based on a rank attribute as well as a binary attribute for each program item. In other implementations, the demultiplexer 205 can group program items into sets according to predetermined assignments.

Additionally, in some implementations, program items can also be processed after they have been assigned to sets. For example, program items can be removed from sets if they do not meet certain criteria (e.g., if their attributes either match or do not match a certain value). Such processing can be useful in the creation of dynamic stations.

Returning to the process 300 in FIG. 3, once the program items have been grouped into sets, the programming system 200 receives a specification of a set sequence (step 306). This is shown as the clock sequence input 220 to the sequence generator 250 in FIG. 2. As the name implies, the set sequence is a sequence of sets. For example, assuming a system with 4 sets, a set sequence can be as follows: set 1, set 3, set 2, set 1, set 4, and set 2, with the entire sequence repeating again from the beginning.

The sequence generator 250 can then generate a sequence of program items by selecting program items from the sets based on the indicated set sequence (step 308). For example, given the set sequence specified above, the sequence generator can select the first program item from set 1, followed by the first program item from set 3, followed by the first program item from set 2, followed by the second program item from set 1, and so forth. That is, the sequence generator 250 can select a program item from each set according to the set sequence, looping through the program items in each set if need be. In some implementations, the program items in each set are not ordered, and the sequence generator can select program items from an indicated set based on other criteria (e.g., based on attributes, or on scores computed for each program item in accordance with a set of rules, as discussed in more detail below). In other implementations, the sequence generator can select any available item from an indicated set, or, if there are no program items available in the indicated set, from the next closest set.

In some implementations, the selection and sequencing of program items is based not only on the set sequence, but also on one or more attributes associated with each program item. One example of such an implementation is a system in which one or more rules are used to compute a score for each program item based on the attributes associated with the program item, as well as on the set to which the program item is assigned. In this implementation, the sequence generator selects the program item with the best score as the next program item to insert in the output sequence of program items. An example of such a score-based implementation is discussed in more detail below.

The selection of program items to form a programming stream can be done by the sequence generator 250 at run time—i.e., the programming stream can be created dynamically. As specified above, the input set of program items (i.e., the entire set of program items to be sequenced) can also be assembled dynamically (e.g., based on selections from a user and/or recommendations from a recommendation engine), or it can be provided statically (e.g., based on a description of a station created by a content programmer).

In some implementations, content programmers can describe stations (e.g., Internet radio stations) with varying degrees of precision. For example, a content programmer can describe a station with a high degree of precision by specifying the program items to be played, the sets into which the program items are to be grouped, and the set sequence to be used in selecting program items from the sets. As another example, the content programmer can specify the program items to be played and the set sequence to be used, but leave it up to a demultiplexer 205 to distribute the program items into sets. As a further example where the description of the station has even less precision, the content programmer can specify only the set sequence, and let the programming system assemble the input set of program items dynamically, as well as distribute the program items into sets. Where the input set of program items is assembled dynamically, the content programmer can, in some implementations, specify certain program items or types of program items to be included (e.g., advertisements) or excluded (e.g., songs with explicit lyrics) from the input set of program items.

In some implementations, the sequence of program items generated by the sequence generator 250 can be modified before the program items are played. For example, the generated sequence of program items can be filtered to remove certain program items (e.g., program items that are of a predetermined type, that satisfy a predetermined condition, or that are specified on a list of program items to be excluded). Filtering can be used, for example, to remove advertisements from the programming stream for paying customers, or to remove songs specified on a list (e.g., a list of songs with explicit lyrics, or a list of songs that a user has indicated he does not wish to hear). In other implementations, program items (e.g., advertisements) can be inserted into the sequence of program items generated by the sequence generator 250.

The generated sequence of program items can also be modified by replacing certain program items in the generated sequence with alternative program items. For example, if the sequence generator is used to generate sequences of songs for an over-the-air radio station, a song that has explicit lyrics can be replaced by a “clean” version of the song that does not include the explicit lyrics.

As discussed previously, in some implementations, program items can include proxies, which are items that represent a group of related program items. In such implementations, the generated sequence of program items can be modified to replace proxies in the generated sequence with one or more of the program items that the proxies represent. This feature can be used in many different scenarios. For example, classical music works are frequently broken up into movements that are provided as separate tracks. The movements—i.e., tracks—are meant to be played back-to-back. However, if the tracks are provided to the sequence generator as separate program items, the sequence generator might generate a sequence of songs in which the tracks are not played together. In this scenario, rather than providing the tracks as separate program items, a single proxy can be used to represent the tracks. The sequence generator can select the proxy and insert it into the generated output sequence as it would any other program item. After the proxy has been inserted into the generated output sequence, the proxy can be replaced by the separate tracks that the proxy represents. In this manner, the tracks are played together, thus preserving the continuity of the work of which they are a part.

As another example, a proxy can be used to represent a group of alternative versions of a program item. For example, a proxy might represent a “clean” version and an explicit version of a song. Such a proxy can be replaced with one of two versions of the song, depending on the context in which the songs are being played—e.g., the proxy could be replaced by the “clean” version of the song for an over-the-air broadcast, and the explicit version of the song for an Internet broadcast.

In some implementations, a generated sequence of program items can also be modified by combining or merging the generated sequence with one or more additional sequences of program items. For example, if one sequence of songs is generated for a first radio station, and a second sequence of songs is generated for a second radio station, those two stations can be blended by combining their two sequences. Multiple stations (e.g., three or more stations) can also be blended in this manner. In one implementation, a weight is associated with each generated sequence (input sequence) of program items, and a final output sequence is generated by combining each of the input sequences according to its weight. Weights can be based on data from multiple sources, including user data (e.g., user input, user profiles, and user affinity groups).

As described above, the sequence generator 250 can generate a sequence of program items by selecting program items from the sets 201, 202, 203, and 204 based on the indicated set sequence 220. Although the set sequence can be predetermined (e.g., by a content programmer), in some implementations, the set sequence can be based on user data (e.g., input from an end-user 230, or data from a user profile or a user affinity group). For example, information about a user affinity group (e.g., people of a certain age) may indicate that people in that affinity group prefer to hear certain songs (e.g., popular songs) very frequently. In an implementation where songs are grouped into sets based on their popularity, the set sequence for people in that affinity group can be adjusted so that songs from the “very popular” set are played more frequently.

Moreover, in some implementations, the set sequence can be adjusted dynamically based on input from an end-user 230. For example, an application (e.g., a player on a personal computer) can display a graphical user interface (GUI) control (e.g., a slider or a radio button) that lets the user provide input that can be used to adjust the set sequence. The GUI control can represent, for example, how eclectic a mix of songs the user wishes to hear—setting the control to one setting can indicate that the user wants to hear only popular songs, whereas setting the control to a second setting can indicate that the user wants to hear more obscure works. Thus, in an implementation where songs are grouped into sets based on their popularity, the former setting can indicate that the set sequence should be adjusted so that songs from the “very popular” set are played more frequently, and the latter setting can indicate that the set sequence should be adjusted so that songs from the “almost unknown” set are played more frequently.

In some implementations, the GUI control can have more than two settings. For example, the control can be a radio button with four or five settings, or a slider with a much greater number of settings. The set sequence for the different control settings can be predetermined (e.g., if the control is a radio button, or a slider with quantized values), or algorithmically computed (e.g., based on the exact position of a slider if the slider does not have quantized values).

Additionally, in some implementations, the GUI control can have two or more degrees of freedom. Each degree of freedom can represent a different property that the user can adjust. For example, in one implementation, a user can adjust the control in one dimension to indicate how wide a selection of artists should be included in a generated sequence of songs, and in a second dimension to indicate how well-known the songs from the selected range of artists should be. When the control is adjusted in the first dimension, the availability of the songs can be adjusted accordingly. For example, if the user indicates that he does not want to hear songs from a wide range of artists, certain songs (e.g., songs from less popular artists) can be removed from consideration, so that the sequence generator will not select those songs. Songs can be removed from (or added to) consideration in various ways—e.g., by setting an attribute associated with the songs to be removed from (or added to) consideration, and checking that attribute before selecting a song. Alternatively, a rule can be established and used in the selection of the program items. Such a rule can be used to specify directly whether program items are available or unavailable, or it can be used to assign points to certain program items, as described below. When the control is adjusted in the second dimension, the set sequence can be adjusted accordingly, as described above. In some implementations, the degrees of freedom can be orthogonal (independent), which means that the corresponding properties can be adjusted by the user independently of each other.

In the implementations discussed thus far, the sequence generator 250 generates a sequence of program items by selecting program items from the sets according to the indicated set sequence 220. In an alternative implementation, the set sequence can serve as input to the sequence generator 250, but it does not necessarily represent the final sequence of program items that is generated. Rather, the sequence of program items that is generated is also based on a set of programming rules 130, as described below.

In one implementation, the sequence generator 250 assigns each program item in the entire input set of program items a score based on programming rules. One of the rules can be, for example, to add a point to the score of a program item if the program item is in the set that the set sequence indicates should be chosen from next. The sequence generator can then identify the best program item (e.g., the program item with the highest score), and select that program item as the next program item to play. The sequence generator then repeats the entire process, scoring each program item and selecting the best program item as the next program item in the generated sequence.

In another implementation, each programming rule specifies a penalty to assign to a program item if the program item does not comply with the rule. For example, the sequence generator 250 can use the rules and penalties shown in Table 3 below.

TABLE 3

| Rule | Penalty |
|---|---|
| Song should be in the next set designated by the set sequence. | 100 |
| Song should not have been played within the past 3 hours. | 80 |
| Artist should not have been played within the past 1.5 hours. | 50 |
| Song should not have a harsh transition in speed from | 30 |
| the previous song. | |
| Song should not violate a licensing provision or an intellectual | 1,000 |
| property law. | |

In this implementation, the sequence generator 250 computes a score for each program item by adding up all the penalties for the program item, and then selects the program item with the lowest score (i.e., the program item with the least penalty points) as the next program item in the generated sequence.

The scores or penalties for the rules can be set to reflect the relative priorities of the rules—e.g., the important rules can be assigned high penalties, and minor rules can be assigned low penalties. If the sequence generator 250 is programmed to select the program items with the lowest penalties, that means that minor rules (e.g., rules with low penalties) are likely to be broken first, and that important rules (e.g., rules with high penalties) are likely to be violated less frequently. In the example above, setting the penalty for the last rule (program items should comply with licensing provisions and intellectual property laws, e.g., the Digital Millennium Copyright Act) to a very high value (e.g., to a value that is greater than all the other combined penalties), makes it very unlikely that that rule will be violated.

In some implementations, a threshold can be established to ensure that the sequence generator never selects a program item with a score above or below the given threshold. For example, where scores represent penalty points, a threshold can be established so that the sequence generator never selects program items with more penalty points than the threshold. This feature can be used to ensure that a rule is never violated. For example, in an implementation that uses the rules and penalty points in Table 3, a threshold value of 999 can be set to make sure that the sequence generator never selects a song that violates a licensing or intellectual property provision. To accomplish enforcement of that rule, the sequence generator can be set to stop and generate an error if there are no songs available that have a score below the indicated threshold. In some implementations, thresholds can be configurable and/or adjusted dynamically.

In some implementations, rules can be based on user data (e.g., input from an end-user 230, or data from a user profile or a user affinity group) or on attributes. For example, information about a user affinity group (e.g., people of a certain age) may indicate that people in that affinity group prefer to hear the songs they like frequently. Based on such information, one or more rules can be adjusted accordingly. For example, the penalty for the rule in Table 3 that specifies that songs should not be repeated for 3 hours can be set to a lower value.

Moreover, in some implementations, rules can be adjusted dynamically. For example, rules may be modified (e.g., based on user data such as input from an end-user 230). For example, a user may indicate in a list of preferences that she really dislikes abrupt transitions in the speed of songs. In such a scenario, the penalty for the corresponding rule in Table 3 can be adjusted to a higher value. Rules can also be dynamically generated, and added to or removed from the set of rules used to compute scores. For example, a rule that references a program item previously placed in the generated sequence of program items can be added to the set of rules. Such a rule can be used, for example, to increase the penalty for that program item (as well as for related program items, e.g., songs from the same artist), so that that program item is not likely to be selected again for a period of time. In some implementations, rules can include a specification of program items to which the rules apply, or an indication of a period of time during which the rules are to apply (e.g., a specified number of minutes, or the playing of a specified number of program items).

As described above, two or more generated sequences of program items can be combined (e.g., using weights) to produce a composite output sequence of program items. Conceptually, each generated sequence represents a station (e.g., a radio station), which can be thought of as a combination of a set of program items, a clock or set sequence, and a set of rules or criteria to be used in generating a sequence of program items for that station. In some cases, the set of rules may be null, meaning in essence that no rules are provided and that the generated sequence of program items for that station is to be determined by the clock sequence. Combining generated sequences from multiple stations as described above results in the production of a blended station that is a composite of the individual stations.

As explained above, the process 300 shown in FIG. 3 is a sample process for generating sequences of program items. Although shown as one process in FIG. 3, in practice, this process can be divided into multiple parts. In one implementation, the process is divided into two primary parts: a static part and a dynamic part.

The static part of the process includes the pre-generation steps (e.g., assembling the input set of program items, grouping the program items into sets, and specifying a clock sequence and a set of programming rules). These activities can be performed in an offline or “batch” mode. For example, these activities can be performed by a content programmer or by an automated system (or both) on a weekly basis.

The dynamic part of the process includes the actual generation steps (e.g., selecting the program items from the sets according to the clock sequence and programming rules), as well as the post-generation processing steps (e.g., modifying the generated sequence by replacing proxies, and combining multiple generated sequences into a blended sequence). These activities can be performed on a runtime or on-demand basis. For example, these activities can be performed when an end-user selects or creates an Internet radio station and generates a request for a program stream by pressing a “play” or “download” button in a user interface.

In other implementations, the process can be performed all at once, or divided into different parts to be performed separately or possibly concurrently.

Various implementations of the systems and techniques described here can be realized in digital electronic circuitry, integrated circuitry, specially designed ASICs (application-specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device. Such computer programs (also known as programs, software, software applications or code) may include machine instructions for a programmable processor, and may be implemented in any form of programming language, including high-level procedural and/or object-oriented programming languages, and/or in assembly/machine languages. A computer program may be deployed in any form, including as a stand-alone program, or as a module, component, subroutine, or other unit suitable for use in a computing environment. A computer program may be deployed to be executed or interpreted on one computer or on multiple computers at one site, or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; CD-ROM and DVD-ROM disks; and programmable logic devices (PLDs). The processor and the memory can be supplemented by, or incorporated in special purpose logic circuitry.

As used herein, the term “machine-readable medium” refers to any computer program product, apparatus, and/or device used to provide machine instructions and/or data to a programmable processor, including any type of mass storage device or information carrier specified above, as well as any machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a cathode ray tube (CRT) or liquid crystal display (LCD) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., a database or a data server), a middleware component (e.g., an application server), or a front-end component (e.g., a client computer having a user interface, such as a graphical user interface or a Web browser, through which a user can interact with an implementation of the systems and techniques described herein), or any combination of such back-end, middleware, or front-end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

The processes and logic flows described herein may be performed by one or more programmable processors executing a computer program to perform the functions described herein by operating on input data and generating output. The processes and logic flows may also be performed by, and the systems and techniques described herein may be implemented as, special purpose logic circuitry, e.g., a field programmable gate array (FPGA) or an ASIC.

The foregoing has been described in terms of particular embodiments. Other embodiments may be implemented. For example, the logic flow depicted in FIG. 3 does not require the particular order shown, or sequential order, to achieve desirable results (e.g., the step of receiving a specification of a set sequence may be performed at many different places within the overall process). In certain implementations, multitasking and parallel processing may be preferable. Other embodiments may be within the scope of the following claims.

What is claimed is:

1-43. (canceled)

44. A computer readable non-transitory storage medium for tangibly storing thereon computer readable instructions that when executed cause at least one processor to:
receive, from a data store, a specification of a set sequence;
receive, from a demultiplexer, a specification of multiple sets, each set comprising one or more program items;
generate an output sequence of the program items by selecting the program items from the sets based on the set sequence; and
modify the output sequence of the program items.

45. The computer readable non-transitory storage medium of claim 44, the instructions to modify the output sequence of the program items further comprising instructions to:
remove one or more of the program items from the output sequence of the program items.

46. The computer readable non-transitory storage medium of claim 44, the instructions to modify the output sequence of the program items further comprising instructions to:
add one or more additional program items to the output sequence of the program items.

47. The computer readable non-transitory storage medium of claim 44, the instructions to modify the output sequence of the program items further comprising instructions to:
replace one of the program items in the output sequence with an alternative program item.

48. The computer readable non-transitory storage medium of claim 44, the instructions to modify the output sequence of the program items further comprising instructions to:
replace a program item in the output sequence that is a proxy representing two or more related program items with one or more of the related program items.

49. The computer readable non-transitory storage medium of claim 44, the instructions to modify the output sequence of the program items further comprising instructions to:
combine the output sequence of the program items with at least one additional sequence of the program items.

50. The computer readable non-transitory storage medium of claim 49, the instructions to combine the output sequence of the program items with at least one additional sequence of the program items further comprising instructions to:
select the program items from the output sequence and from the at least one additional sequence according to a first weight associated with the output sequence and an additional weight associated with each additional sequence.

51. A method comprising:
receiving, by at least one computing device from a data store, a specification of a set sequence;
receiving, by the at least one computing device from a demultiplexer, a specification of multiple sets, each set comprising one or more program items;
generating, by the at least one computing device, an output sequence of the program items by selecting the program items from the sets based on the set sequence; and
modifying, by the at least one computing device, the output sequence of the program items.

52. The method of claim 51, modifying the output sequence of the program items further comprising:
removing one or more of the program items from the output sequence of the program items.

53. The method of claim 51, modifying the output sequence of the program items further comprising:
adding one or more additional program items to the output sequence of the program items.

54. The method of claim 51, modifying the output sequence of the program items further comprising:
replacing one of the program items in the output sequence with an alternative program item.

55. The method of claim 44, modifying the output sequence of the program items further comprising:
replacing a program item in the output sequence that is a proxy representing two or more related program items with one or more of the related program items.

56. The method of claim 44, modifying the output sequence of the program items further comprising:
combining the output sequence of the program items with at least one additional sequence of the program items.

57. The method of claim 56, combining the output sequence of the program items with at least one additional sequence of the program items further comprising:
selecting the program items from the output sequence and from the at least one additional sequence according to a first weight associated with the output sequence and an additional weight associated with each additional sequence.

58. A system comprising:
a processor;
a storage medium for tangibly storing thereon program logic for execution by the processor, the stored program logic comprising:
receiving logic executed by the processor for receiving, from a data store, a specification of a set sequence;
receiving logic executed by the processor for receiving, from a demultiplexer, a specification of multiple sets, each set comprising one or more program items;
generating logic executed by the processor for generating an output sequence of the program items by selecting the program items from the sets based on the set sequence; and
modifying logic executed by the processor for modifying the output sequence of the program items.

59. The system of claim 58, the modifying logic executed by the processor for modifying the output sequence of the program items further comprising:
removing logic executed by the processor for removing one or more of the program items from the output sequence of the program items.

60. The system of claim 58, the modifying logic executed by the processor for modifying the output sequence of the program items further comprising:
adding logic executed by the processor for adding one or more additional program items to the output sequence of the program items.

61. The system of claim 58, the modifying logic executed by the processor for modifying the output sequence of the program items further comprising:
replacing logic executed by the processor for replacing one of the program items in the output sequence with an alternative program item.

62. The system of claim 58, the modifying logic executed by the processor for modifying the output sequence of the program items further comprising:
replacing logic executed by the processor for replacing a program item in the output sequence that is a proxy representing two or more related program items with one or more of the related program items.

63. The system of claim 58, the modifying logic executed by the processor for modifying the output sequence of the program items further comprising:
combining logic executed by the processor for combining the output sequence of the program items with at least one additional sequence of the program items.

64. The system of claim 63, the combining logic executed by the processor for combining the output sequence of the program items with at least one additional sequence of the program items further comprising:
selecting logic executed by the processor for selecting the program items from the output sequence and from the at least one additional sequence according to a first weight associated with the output sequence and an additional weight associated with each additional sequence.
